(19) United States
(12) Patent Application Publication
(10) Pub. No.: US 2008/0089964 A1
(43) Pub. Date: Apr. 17, 2008

(54) Drive of molding system

(75) Inventors: Payman Kianpour, North York (CA); Martin Richard Kestle, Everett (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: HUSKY INJECTION MOLDING SYSTEMS LTD., Bolton (CA)

(21) Appl. No.: 11/549,207

(22) Filed: Oct. 13, 2006

(51) Int. Cl. B29C 45/00

(52) U.S. Cl. 425/150; 425/589; 425/595; 318/560

(57) ABSTRACT

Disclosed is: (i) a hydraulic drive of a molding system, (ii) a molding system having a hydraulic drive, (iii) a method of a hydraulic drive of a molding system, (iv) a controller of a drive of a molding system, (v) an article of manufacture of a controller of a drive of a molding system, and (vi) a network-transmittable signal of a controller of a drive of a molding system.

### TECHNICAL FIELD

The present invention generally relates to, but is not limited to, molding systems, and more specifically the present invention relates to, but is not limited to, (i) a hydraulic drive of a molding system, (ii) a molding system having a hydraulic drive, (iii) a method of a hydraulic drive of a molding system, (iv) a controller of a drive of a molding system, (v) an article of manufacture of a controller of a drive of a molding system, and (vi) a network-transmittable signal of a controller of a drive of a molding system.

### BACKGROUND

Examples of known molding systems are (i) the HyPE™ Molding System, (ii) the Quadloc™ Molding System, (iii) the Hylectric™ Molding System, and (iv) the HyMet™ Molding System, all manufactured by Husky Injection Molding Systems Limited (Location: Bolton, Ontario, Canada; www.husky.ca).

U.S. Pat. NO. 3,825,384 (Inventor: Hehl; Published: 1974-07-23) discloses a mold closure unit that operates at low pressure to open and close a mold and at high pressure to seal a mold. More specifically, the patent discloses a hydraulic drive system for the mold closing unit of an injection molding or die casting machine in which drive cylinders are provided in circuit with a pump system which alternatingly provides pressure levels in at least a low pressure range and a high pressure range for the closing unit. In one embodiment, the pump system effects a closing stroke and an opening stroke of the mold by applying a pressure in the low pressure range, and retains the closed state of the mold by applying a pressure in the high pressure range. A slide valve and a pressure setting valve are connected in circuit with the drive cylinders and the pump, with the pressure setting valve opening at a pre-selected limit pressure which is lower than the lower pressure range, while the slide valve is maintained in an open position during the latter portion of the closing stroke of the mold. In another embodiment, the pump system effects a closing stroke and an opening stroke of the mold by applying a pressure in the low pressure range, and retains the closed state of the mold by applying a pressure in the high pressure range with the pressure setting valve opening at a pre-selected limit pressure which lies slightly above the pressure ranges.

U.S. Pat. No. 4,712,991 (Inventor: Hehl; Published: 1987-12-15) discloses a plastics injection molding machine hydraulic device that has pressure controlling unit and travel distance control unit. More specifically, the patent discloses a hydraulic control system for the operation of three linear and one rotary hydraulic drive assemblies of the injection unit of an injection molding machine that includes a variable delivery pump supplying drive fluid at a constant pressure gradient to several supply lines controlled by two control units which are arranged in parallel and feature proportional P/Q valves and pressure transducers, a smaller pressure maintenance pump which is controllable by a third proportional P/Q valve and switchable into one of the supply lines, and a hydraulic accumulator for the temporary supply of a large quantity of drive fluid. The proportional P/Q valves convert automatically from their flow rate programs, controlled by displacement-to-voltage converters on the injection unit, to pressure programs controlled by the pressure transducers.

U.S. Pat. No. 5,052,909 (Inventor: Hertzer et al; Published: 1991-10-01) discloses a hydraulic injection molding machine that incorporates a pump driven by a variable speed motor preferably of the brushless DC type. The machine controller outputs driving signals to adjust the speed of the motor so that the flow delivered by the pump substantially matches the hydraulic demand imposed during each phase of the machine operating cycle. The pump is preferably a variable displacement type and is connected to a fast responding pump control for selectively carrying out pressure compensation or flow compensation. The values of the motor driving signals are calculated so that the motor/pump combination is operated at or near maximum efficiency except when the pump control varies the displacement of the pump to effect pressure or flow compensation. Hydraulic transient response is further improved by connecting the output of the pump to an accumulator by way of a check valve.

U.S. Pat. No. 5,613,361 (Inventor: Dantlgraber et al; Published: 1997-03-25) discloses a hydraulic system (for example an injection molding machine) that operates some units such as extruder on open circuit but others needing precise movements of heavy masses are moved by closed circuit. Specifically, the patent discloses a hydraulic circuit for supplying a plurality of series-operated consumers of a hydraulically controlled installation, in particular of an injection molding machine, having a pump with feed-flow pressure control. To be able to slow down greater moving masses with very little expenditure in regard to circuitry and devices, only a portion of the consumers, such as the extruder, the injection unit and possibly the ejector are operated in open circulation, while at least one selected further consumer, such as the clamping unit of the injection molding machine, where a greater mass must be moved in alternating directions, is moved in semi-closed or closed circulation.

U.S. Pat. No. 6,379,119 (Inventor: Truninger; Published: 2002-04-30) discloses a power transmission system directly controlling an electrical supply to variable speed motor driving hydraulic positive displacement pump that avoids power dissipation in hydraulic circuit by e.g. bypass and idling using responsive computer control to match performance characteristics and execute wide variety of industrial operations requiring rotary and linear drive. Specifically, there is disclosed a system that includes a pump driven by a variable speed electric motor, the pump being directly connected to a hydraulic actuator by an open hydraulic circuit. This setup allows using one motor pump combination to drive any number of axes sequentially. The main advantages are significant energy savings but also higher control quality achieved by the substitution of control valves. Power control is dedicated to electronic power transistors while hydraulics are used for power transmission. For two and four quadrant operation, a hydraulic accumulator is proposed exerting a spring load on the hydraulic actuator. This allows for driving and braking the actuator and the associated machine axis in both directions of motion while the hydraulic pressure is always applied to the same port of the pump. The other pump port can be connected to tank.

U.S. Pat. No. 6,527,540 (Inventor: Dantlgraber; Published: 2003-03-04) discloses a hydraulic circuit for moving a platen on an injection molding machine that includes a differential actuating cylinder supplied by a pump through a pressure reservoir and a hydro-transformer. More specifically, the patent discloses a hydrostatic drive system for an injection molding machine which has a movable mold-closing plate that includes a hydraulic pump and a differential hydraulic cylinder, by which the mold-closing plate can be moved in the direction of the closing position by the feeding of pressure medium into the second pressure space remote from the piston rod and can be moved in the direction of the open position by the feeding of pressure medium into the first pressure space on the piston-rod side. Pressure medium can be delivered by the hydraulic pump into a pressure network having a hydraulic accumulator, and the first pressure space of the hydraulic cylinder is connected to the pressure network, and the hydraulic cylinder is controlled via a hydraulic transformer which is located with its primary-side pressure connection at the pressure network and via the secondary-side pressure connection of which pressure medium can be fed to the second pressure space of the hydraulic cylinder or discharged from the second pressure space. The high demand for pressure medium when the mold-closing plate is being closed during the speed-increasing acceleration phase can be covered to a high degree from the hydraulic accumulator. During the braking of the mold-closing plate, the hydraulic transformer can help to recharge the hydraulic accumulator. During the dead time, during which the mold-closing plate is stationary, the hydraulic accumulator can continue to be filled by the hydraulic pump.

U.S. Pat. No. 6,557,344 (Inventor: Puschel; Published: 2003-05-06) discloses a hydraulic drive system for several hydraulic units, has further hydraulic units connected via directional control valves to a common pressure line. More specifically, the patent discloses a hydraulic drive with a plurality of hydraulic consumers also including a differential cylinder which are located in particular on a plastics injection-molding machine. There are a first hydraulic machine and a second hydraulic machine, which can both operate as pump and as motor. A first of the two hydraulic machines is connected to a tank by means of a second port and rests against a pressure line by means of a first port, which pressure line can be connected to that working chamber of the differential cylinder which is remote from the piston rod via a shut-off valve. The second hydraulic machine is likewise connected to the pressure line by means of a first port and can be connected, by means of a second port, to a tank via a non-return valve which opens toward the second port and to the piston-rod-side working chamber of the differential cylinder via a shut-off valve. According to the invention, the two hydraulic machines are also used to supply at least one further hydraulic consumer with pressure medium. For this purpose, the at least one further hydraulic consumer can be connected to the pressure line via a directional control valve.

U.S. Pat. No. 6,878,317 (Inventor: Kubota; Published: 2005-04-12) discloses a hydraulic actuating mechanism for an injection molding machine for controlling discharged fluid pressure by discharge cut-off function of pressure compensator ancillary to variable discharge pump. More specifically, the patent discloses a hydraulic actuating mechanism of an injection molding machine, in which a plurality of hydraulic actuators are driven by one hydraulic pump, wherein the hydraulic pump of the hydraulic actuating mechanism is a variable discharge pump having the maximum necessary delivery capacity at least for each of the hydraulic actuators at the time of the highest rotational speed of the pump; the discharged fluid pressure is controlled by a discharge cutoff function of a pressure compensator ancillary to the variable discharge pump; and the pump is driven by a motor whose rotation can be controlled in a step-less mode.

### SUMMARY

According to a first aspect of the present invention, there is provided a drive of a molding system, including, a first hydraulic machine, and a second hydraulic machine cooperative with the first hydraulic machine, the first hydraulic machine and the second hydraulic machine being operative in a push-pull operation mode.

According to a second aspect of the present invention, there is provided a drive of a molding system, including, a first hydraulic machine configured to cooperate with a second hydraulic machine, the first hydraulic machine and the second hydraulic machine being operative in a push-pull operation mode.

According to a third aspect of the present invention, there is provided a molding system, including, a drive, including: (i) a first hydraulic machine, and (ii) a second hydraulic machine cooperative with the first hydraulic machine, the first hydraulic machine and the second hydraulic machine being operative in a push-pull operation mode.

According to a fourth aspect of the present invention, there is provided a molding system, including, a movable component, an actuator coupled to the movable component and configured to move the movable component, and a drive, including: (i) a first hydraulic machine, and (ii) a second hydraulic machine cooperative with the first hydraulic machine, the first hydraulic machine and the second hydraulic machine being operative in a push-pull operation mode.

According to a fifth aspect of the present invention, there is provided a method of a hydraulic drive, including, operating a first hydraulic machine and a second hydraulic machine in a push-pull operation mode.

According to a sixth aspect of the present invention, there is provided a controller of a drive of a molding system, the controller including a controller-usable medium embodying instructions being executable by the controller, the controller operatively couplable to the drive, the drive having a first hydraulic machine and a second hydraulic machine, the instructions including executable instructions for directing the controller to operate the first hydraulic machine and the second hydraulic machine in a push-pull operation mode.

According to a seventh aspect of the present invention, there is provided an article of manufacture of a controller of a drive of a molding system, the article of manufacture including a controller-usable medium embodying instructions being executable by the controller, the controller operatively couplable to the drive, the drive having a first hydraulic machine and a second hydraulic machine, the instructions including executable instructions for directing the controller to operate the first hydraulic machine and the second hydraulic machine in a push-pull operation mode.

According to a eigth aspect of the present invention, there is provided a network-transmittable signal of a controller of a drive of a molding system, the network-transmittable signal including a carrier signal modulatable to carry instructions being executable by the controller, the controller operatively couplable to the drive, the drive having a first hydraulic machine and a second hydraulic machine, the instructions (502) including executable instructions for directing the controller to operate the first hydraulic machine and the second hydraulic machine in a push-pull operation mode.

A technical effect, amongst other technical effects, of the aspects of the present invention is improved operation of a molding system.

### BRIEF DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

FIG. 1 is a schematic representation of a drive of a molding system according to a first exemplary embodiment (which is the preferred embodiment);

FIG. 2A is a schematic representation of the drive of FIG. 1 used for applying a stroking force to a movable platen so as to close a mold of the molding system;

FIG. 2B is a schematic representation of the drive of FIG. 1 used for applying a mold break force to a mold of the molding system;

FIG. 2BB is a schematic representation of the drive of FIG. 1 used for applying a mold break force to a mold of the molding system according to a variant;

FIG. 2C is a schematic representation of the drive of FIG. 1 used for applying a stroking force to a movable platen so as to open a mold of the molding system;

FIG. 3A is a schematic representation of the drive of FIG. 1 used for applying an injection stroke to a screw of an extruder to inject a molding material into a mold of the molding system;

FIG. 3B is a schematic representation of the drive of FIG. 1 used for applying holding force to a molding material that has been injected into a mold of the molding system;

FIG. 3C is a schematic representation of the drive of FIG. 1 used for applying a pullback stroke a screw of an extruder so as to retract the screw from a mold of the molding system;

FIG. 3CC is a schematic representation of the drive of FIG. 1 used for applying a recovery stroke to the system of FIG. 1 so as to recover a shot of molding material;

FIGS. 4A, 4B, 4C are schematic representations of the drive of FIG. 1 used for applying a carriage stroke force to an extruder so as to move the extruder relative to a mold of the molding system;

FIGS. 5A and 5B are schematic representations of the drive of FIG. 1 used for applying a clamping force to a mold of the molding system; and

FIG. 6 is a schematic representation of a controller that is operatively cooperative with the drive 100 of FIG. 1.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

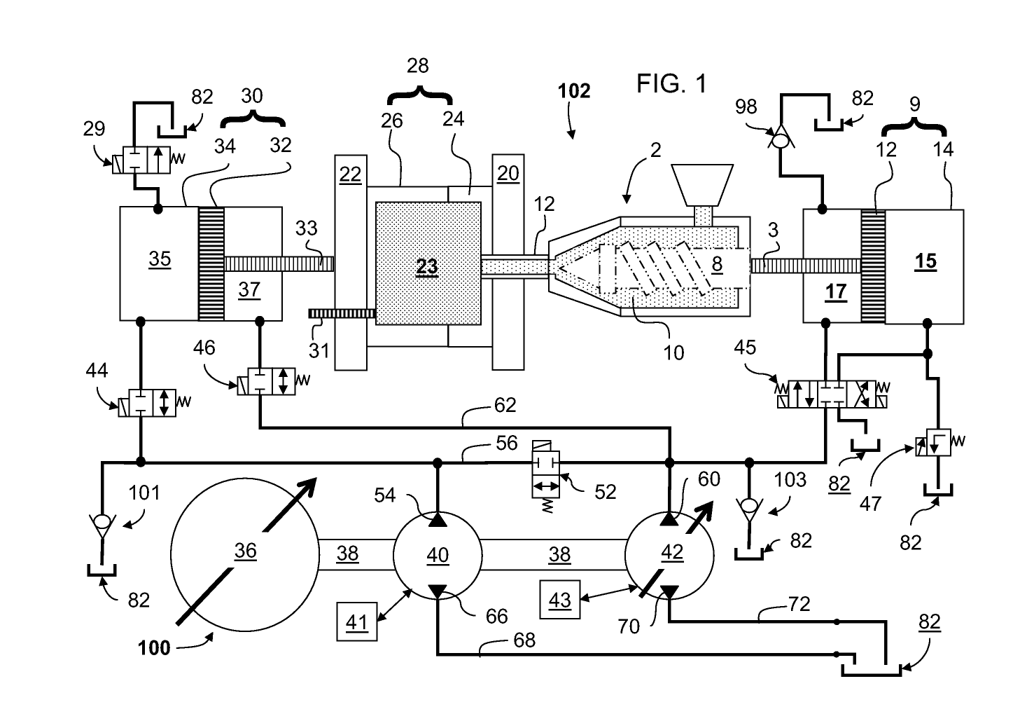

FIG. 1 is a schematic representation of a drive 100 of a molding system 102 (hereafter referred to as the “system 102”) according to the first exemplary embodiment. In FIG. 1, the drive 100 and the system 102 are depicted in a reset state or an initial state (in which no items or components are activated). Preferably, the system 102 includes an extruder 2 that has a screw 8. The screw 8 is used to process a molding material 10. A machine nozzle 12 connects the extruder 2 to a mold 28. According to a variant (not depicted), the machine nozzle 12 is connected to a hot runner (not depicted), and the hot runner is used to distribute the molding material 10 into the mold 28 (the mold 28 may have a single cavity or multiple cavities). The mold 28 includes a stationary mold portion 24 that is supported by a stationary platen 20 (the machine nozzle 12 passes through the stationary platen 20). The mold 28 also includes a movable mold portion 26 that is supported by a movable platen 22 that is movable relative to the stationary platen 20. The screw 8 is connected to an actuator 9 and the actuator 9 is used to stroke or to move the screw 8. The movable platen 22 is connected to an actuator 30 and the actuator 30 is used to stroke or to move the movable platen 22.

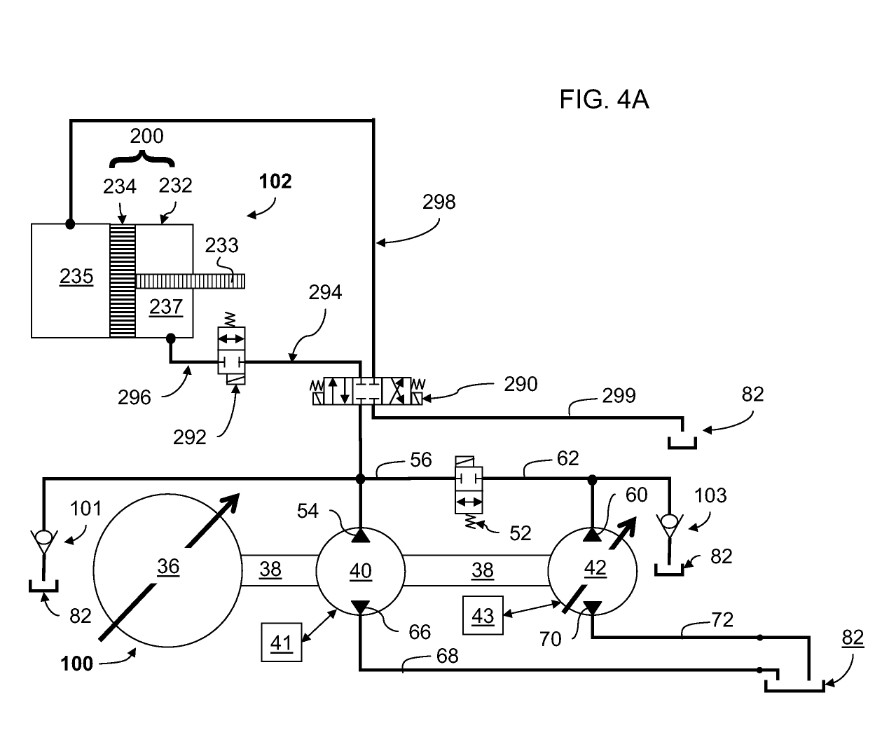

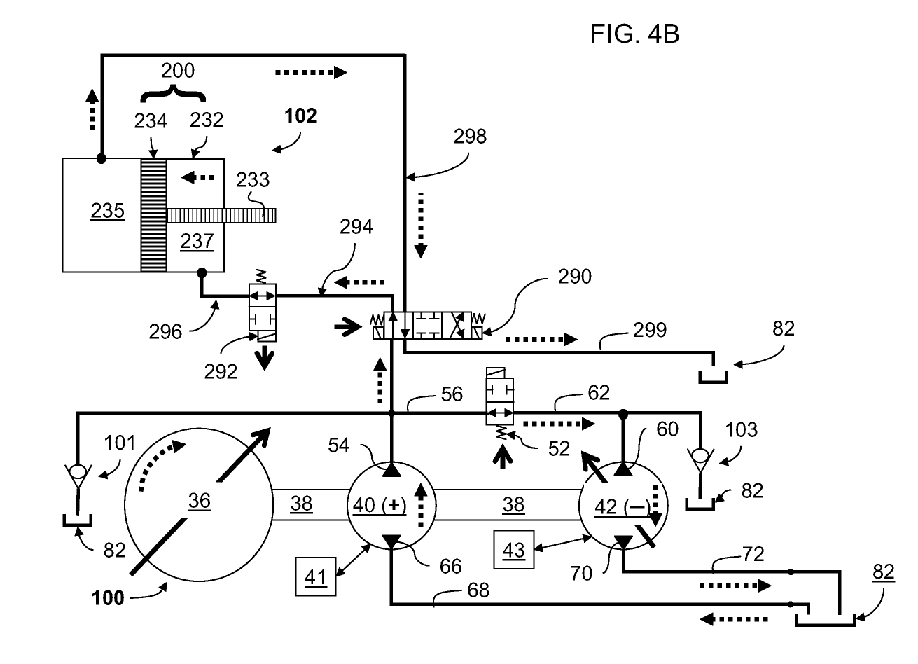

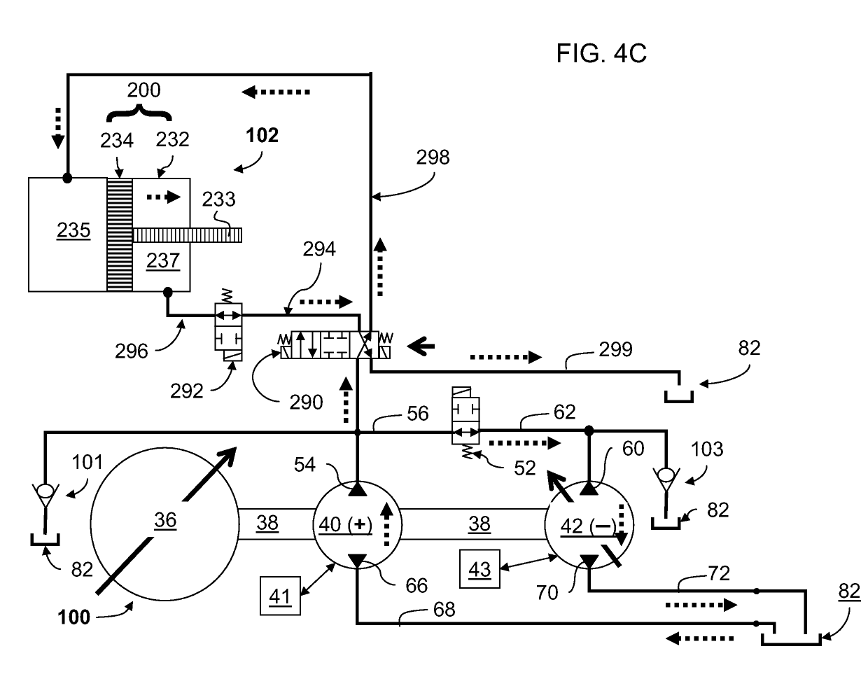

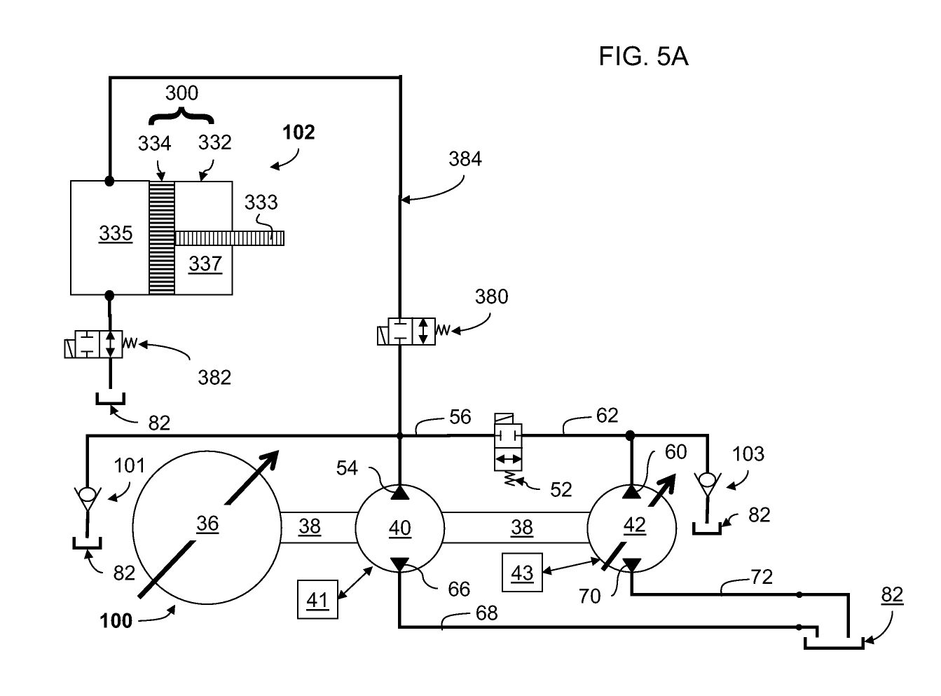

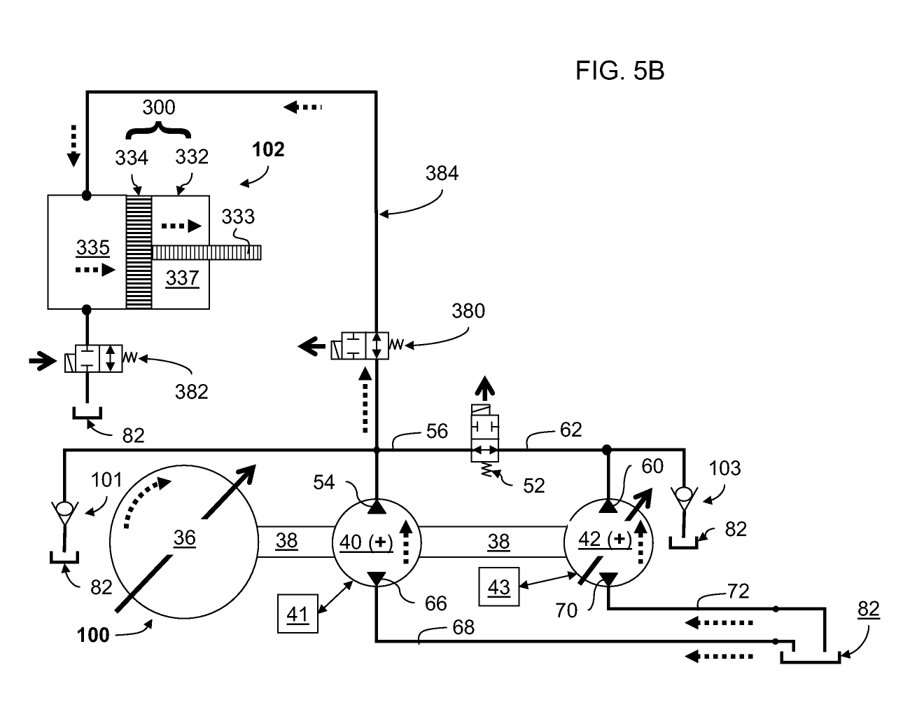

The drive 100 is used to drive the actuators 9 and 30 by bringing a fluid (preferably, a hydraulic fluid or a pressurized fluid): (i) from a tank 82 to the actuators 9, 30, and (ii) from the actuators 9, 30 back to the tank 82. Depicted in FIGS. 4A, 4B, 4C, FIGS. 5A, 5B, the drive 100 can bring or deliver the fluid to an actuator 200 and to an actuator 300, respectively. 024 The drive 100 includes a first hydraulic machine 40 (hereafter referred to as the “machine 40”) and a second hydraulic machine 42 (hereafter referred to as the “machine 42”) that is cooperative with the machine 40. The machine 40 and the machine 42 are operative in a push-pull operation mode. Preferably, the machine 40 and the machine 42 are also operative in a uni-push operation mode. Even more preferably, the machine 40 and the machine 42 are operative in an operation mode selected from one of (i) a push-pull operation mode and (ii) a non-push-pull operation mode. In the non-push-pull operation mode, both of the machines 40, 42 deliver the fluid to a selected a side of an actuator, such as actuators 9 and 30, etc, (preferably, the machines 40, 42 act as a single variable-displacement pump). In the push-pull operation mode, a selected one of the machines 40, 42 pushes the fluid to a selected side of the actuator while the other selected one of the machines 40, 42 pulls the fluid from another selected side of the actuator (preferably, the machines 40, 42 act as separate machines).

Preferably, the drive 100 also includes a motor 36 that is coupled, preferably by a shaft 38, to the machine 40; the motor 36 is also coupled, preferably by the shaft 38, to the machine 42. Preferably, but limited to, the motor 36 includes a servo motor. More preferably, the motor 36 includes a permanent-magnet servo motor. And yet even more preferably, the motor 36 includes an AC synchronous servo motor. The motor 36 is reverse rotatable in that the motor 36 may rotate forwardly or backwardly (that is, clockwise or counterclockwise). Preferably, but not limited to, the machine 40 includes a hydraulic pump; more preferably, the machine 40 includes a fixed-displacement type hydraulic pump. Preferably, but limited to, the machine 42 includes a hydraulic pump; and more preferably, the machine 42 includes a variable-displacement type hydraulic pump. The machines 40 and 42 are both equipped with controllers 41 and 43, respectively that are programmable. Preferably, the machine 42 is pre-adjustable in terms of the displacement and direction of flow of the fluid. Pre-adjustment of a displacement setting of the machine 42 is between, for example (but not limited to), a hundred per cent (+100%) and minus hundred per cent (−100%) or in between these maximum displacement settings. The machines 40 and 42 can both be selectively operated both as a hydraulic pump and as a hydraulic motor. Preferably, but limited to, the displacement of the machine 40 is fixed (+100% displacement) while the displacement of the machine 42 is variable (from −100% to +100% displacement). The machines 40, 42 are mechanically coupled to the motor 36 in such a manner that the machines 40, 42 can both be (i) driven by the motor 36 and can also (ii) drive the motor 36.

A primary port 54 of the machine 40 is connected to a pressure line 56 which leads, via a shut-off valve 44 (hereafter referred to as the “valve 44”) to a bore side 35 of the actuator 30. The bore side 35 may be also called a first chamber. The actuator 30, preferably, includes a differential cylinder 34. A piston 32 is received in the cylinder 34 and the piston 32 is linearly movable in the cylinder 34. A rod 33 is attached to the piston 32 and the rod 33 extends out from the cylinder 34. The rod 33 is attached to, generally, a movable mass, and more specifically the rod 33 is attached to the movable platen 22 of the system 102. The cylinder 34 has a bore side 35 and a rod side 37 (the rod 33 extends through the rod side 37). The rod side may be called a second chamber. A shut-off valve 29 (hereafter referred to as the “valve 29”) is connected to the bore side 35, and the valve 29 is in turn connected to the tank 82. When the fluid is made to fill the bore side 35, the piston 32 is moved so as to extend the rod 33 (also called a shaft). When the fluid fills the rod side 37, the piston 32 is moved so as to retract the rod 33. When the bore side 35 is pressurized and the rod side 37 is un-pressurized, the piston 32 and the rod 33 are moved so as to extend the rod 33 from the cylinder 34. When the bore side 35 is un-pressurized and the rod side 37 is pressurized, the piston 32 and the rod 33 are moved so as to retract the rod 33 from the cylinder 34. Specifically, the actuator 30 is used to implement a platen-stroking function (that is, movement of the movable platen 22). Other actuators that may be drivable by the drive 100 can be used to implement other functions, such as (but not limited to): (i) breaking the mold 28 (that is, breaking apart the mold 28 to release a molded article 23 from the mold 28, (ii) applying a clamp force to the mold 28, (iii) moving an ejector 31 that is used to eject the molded article 23 from the mold 28 after the mold has been broken and separated, (iv) position the extruder 2 (also called an injection unit) and a nozzle 12 relative to the mold 28, (v) injecting a molten molding material 10 into the mold 28, and/or (vi) drive (stroke and/or rotate) a screw 8, etc. A port 66 of the machine 40 is connected to a tank line 68 that leads to a tank 82. The machine 40 be operated to deliver the fluid from the tank 82 to the pressure line 56 and in this case the machine 40 operates as a pump. The machine 40 can also be operated to deliver the fluid from the pressure line 56 to the tank 82 and in this case the machine 40 operates as a hydraulic motor.

The primary port 54 of the machine 40 is connected to a shut-off valve 52 (hereafter referred to as the “valve 52”), and the valve 52 is connected to an auxiliary port 60 of the machine 42. When the state of the valve 52 changes from a no-flow condition to a flow condition, the valve 52 connects the auxiliary port 60 to the pressure line 56. When the state of the valve 52 changes from the flow condition to the non-flow condition, the valve 52 disconnects the auxiliary port 60 from the pressure line 56. The state of the valve 52 is changeable either manually (that is under control of an operator) or by computer control (and/or both). The auxiliary port 60 is connected to a pressure line 62, which leads, via a shut-off valve 46 (hereafter referred to as the “valve 46”) to the rod side 37 of the actuator 30. A port 70 of the machine 42 is connected to a tank line 72 which leads to the tank 82. The machine 42 delivers the fluid from the tank 82 to the pressure line 62 and in this case the machine 42 operates as a pump. The machine 42 can also deliver the fluid from the pressure line 62 to the tank 82 and in this case the machine 42 operates as a hydraulic motor.

The primary port 54 of the machine 40 is connected to a primary anti-cavitation valve 101 (hereafter referred to as the “valve 101”), and the valve 101 is connected to the tank 82. The auxiliary port 60 of the machine 42 is connected to an auxiliary anti-cavitation valve 103 (hereafter referred to as the “valve 103”), and the valve 103 is connected to the tank 82.

The auxiliary port 60 is connected to a hydraulic-switching valve 45 (hereafter referred to as the “valve 45”, which is a 3-position valve), which is known in the art. The valve 45 is used to control the operation of the actuator 9. Also connected to the valve 45 is the tank 82. The actuator 9 includes a cylinder 14 that has a piston 12 that is slidably movable in the cylinder 14. The cylinder 14 includes a bore side 15 and a piston side 17. A rod 3 is connected to the piston 12 and extends through the rod side 17 and out from the actuator 9. The rod 3 is connected to the screw 8 of the extruder 2 of the system 102. The bore side 15 is connected to a back-pressure control valve 47 (hereafter referred to as the “valve 47”), and in turn the valve 47 is connected to the tank 82. The valve 45 connects to both the bore side 15 and the rod side 17 of the cylinder 9. A check valve 98 is connected to the rod side 17, and the check valve 98 is in turn connected to the tank 82.

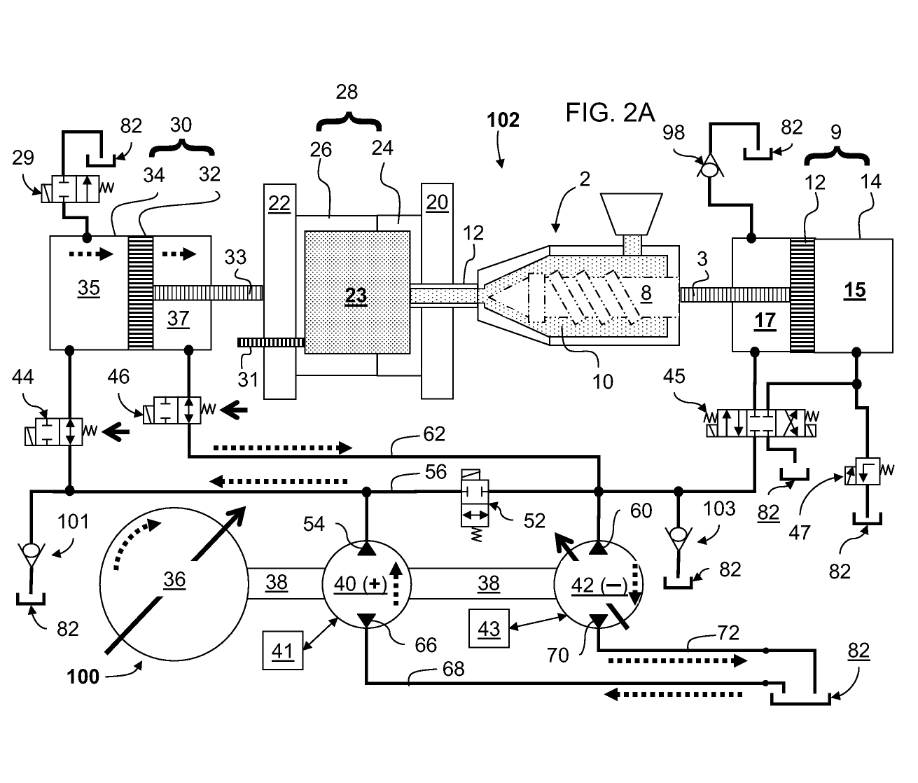

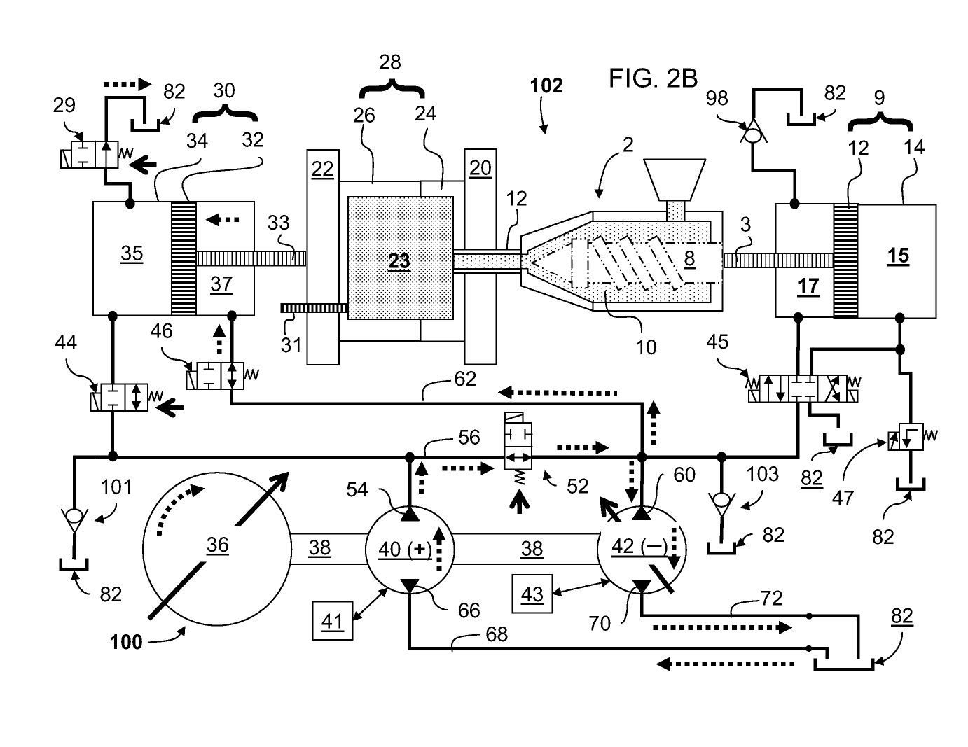

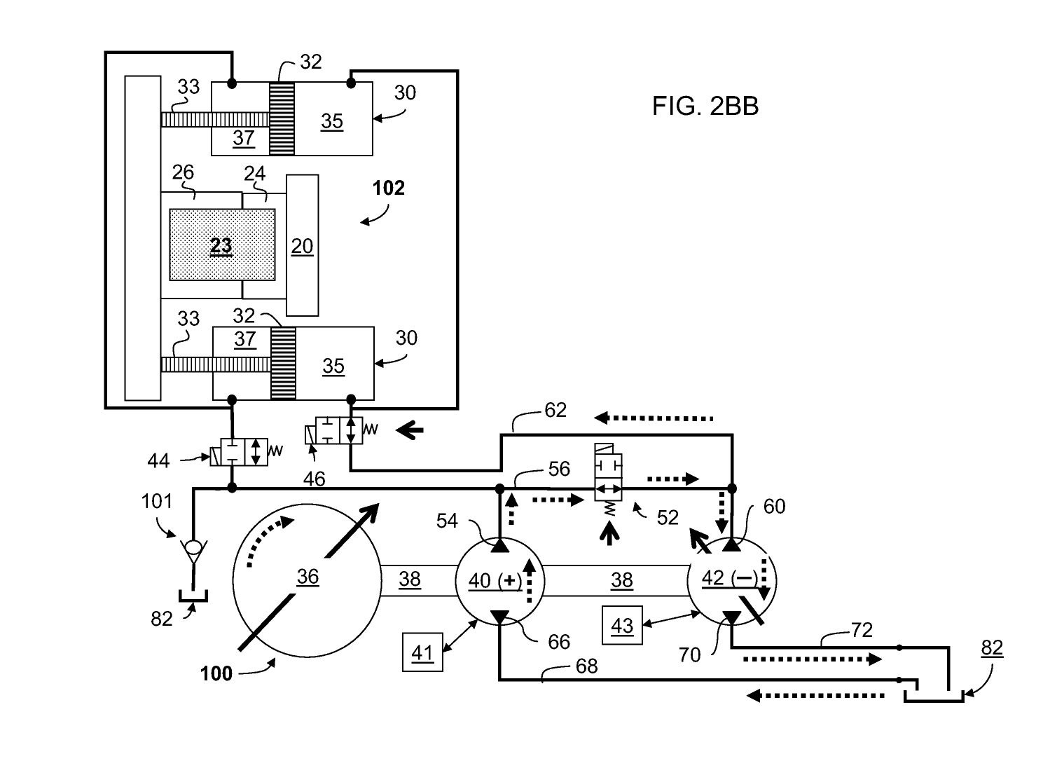

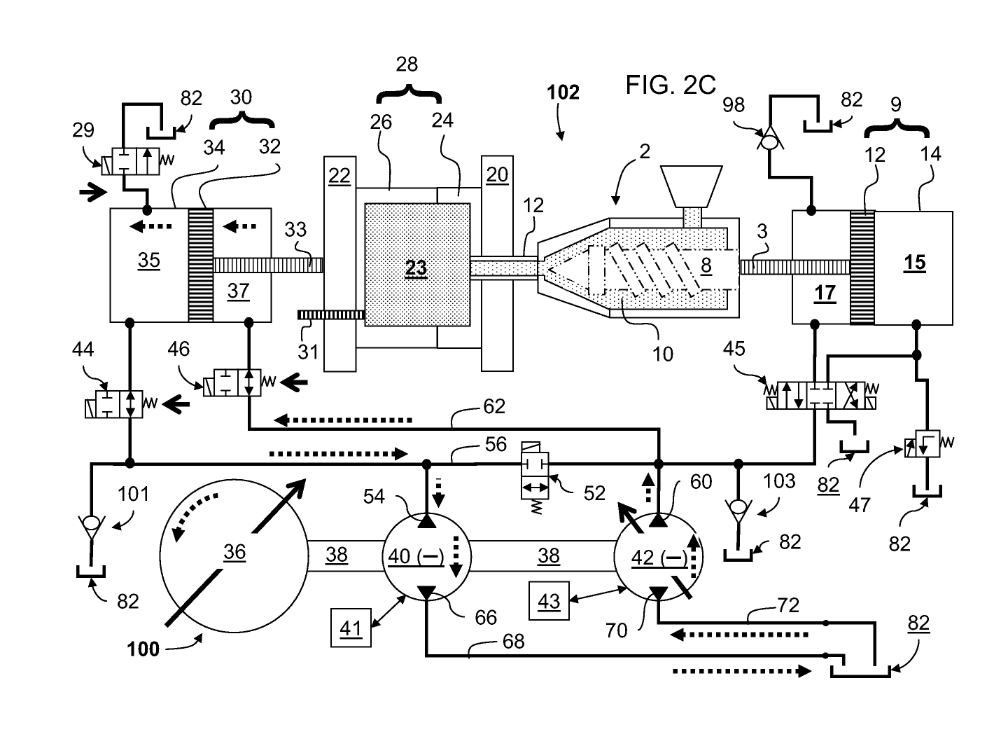

FIG. 2A is a schematic representation of the drive 100 of FIG. 1 used for applying a stroking force to the movable platen 22 so as to close the mold 28 of the system 102. In FIG. 2A, the drive 100 and the system 102 are depicted in a platen-stroke state, in which the movable platen 22 is stroked so as to close the mold 28. In the depicted state, the machines 40, 42 are operated in a low pressure and low flow condition (in the pressure lines 56, 62), and in which energy may be recovered. Preferably, the displacement setting of the machine 40 is set to +100% and the displacement setting of the machine 42 is set to −100%.

In the no-flow condition of the valve 52, the valve 52 does not permit flow of the fluid between the machines 40, 42 so that the machines 40, 42 may operate in the push-pull operation mode, in which the machines 40, 42 act opposite of each other; specifically, if the machine 40 receives (that is, pulls) the fluid from the actuator 30, the machine 42 provides (that is, pushes) the fluid to the actuator 30. If the machine 40 pushes the fluid to the actuator 30, the machine 42 pulls the fluid from the actuator 30 (and so in this sense, the machines 40, 42 operate in the push-pull operation mode). The machine 40 and the machine 42 behave as a complementary pump-motor group (that is, the machine 40 and the machine 42 alternatively behave as a pump and as a motor). FIG. 2A depicts the the machine 40 operated as a pump while the machine 42 is operated as a motor. The machine 40 behaves as a pump by bringing fluid from the tank 82 to the actuator 30 while the machine 42 behaves as a motor by taking the fluid away from the actuator 30 to the tank 82. In this sense the machines 40, 42 act to push and to pull the fluid relative to the actuator 30.

If it is required to move or to extend the rod 33 away or out from the cylinder 32 (that is, the rod 33 moves to the right), (i) the machine 40 takes the fluid from the tank 82 and pushes (pumps) the fluid into the cylinder 34 (specifically the fluid is pumped into the bore side 35), and (ii) the machine 42 pulls the fluid from the rod side 37 of the cylinder 34 and places the fluid in the tank 82 (since the machine 42 is receiving the fluid, the machine 42 behaves as a motor and in that case the machine 42 is regenerating some of the power through the shaft 38).

When a mass is initially accelerated, in the differential-cylinder mode, with the valve 52 closed, and when the mass is initially accelerated, the machines 40, 42 are to behave with one of the machines 40, 42 flowing fluid out (that is, out of the machine), and one of the machine 40, 42 flowing fluid in (that is, flowing the fluid into the machine). In order to do that, it may be required to pre-adjust the displacement of one of the machines 40, 42 to get the flow in the right direction to start with. It may not be desirable to let the machine 40 or 42 to pull the fluid out, as an example, or push the fluid in; it may be desirable to have the one of machines 40, 42 set in the right direction. Another way is that when a differential cylinder is accelerated from rest, one of the machines 40, 42 supplies the fluid and the other one of the machines 40, 42 receives the fluid. If the cylinder is moved to the left, the machine 42 supplies (pushes) the fluid to the rod side 37 (via the pressure line 62). The machine 40 receives (pulls) the fluid from the acutator 30. So at the instant when the drive 100 is energized, pressure is initially built up to get the actuator moving. In the meantime, the machine 42 takes fluid away already in an attempt to cavitate the machine 40. It may not be desired to permit machine 40 to act a little bit, so in that case operation of the machine 40 is delayed a little before the machine 40 actually starts. Either that or some other way is provided to allow the vacuum to be dissipated in the pressure line 56. So in that case, an anti-cavitation valve 101 is used that allows the machine 40 to avoid cavitation. If the valve 52 is set in the flow condition, the machines 40, 42 (in effect) act as a single-variable displacement pump group. If the valve 52 is set in a no-flow condition, then the machines 40, 42 act as separate pump groups (and it may be possible to operate in a regenerative mode to recover energy back into the motor 36). When decelerating a large mass, such as the molvable platen 22, that is attached to the rod 33, energy is recoverable and is fed into the network as electrical energy via the motor 36.

FIG. 2B is a schematic representation of the drive 100 of FIG. 1 used for applying a mold break force to the mold 28 of the system 102. In FIG. 2B, the drive 100 and the system 102 are depicted in a mold-break state, in which the molded article 23 has formed and solidified in the mold 28, and the mold portions 24, 26 of the mold 28 must now be broken apart (forced apart) from each other so that (once the mold 28 has been broken apart) the molded article 23 may then be removed from the mold 28 by an article removing device (not depicted) or by an operator (if so required). For the sake of convenience, the rod side 37 of the actuator 20 is pressurized so as to apply the mold break force to the platen 22. The displacement setting of the machine 42 may be set to a positive setting provided that the motor 36 has sufficient torque to handle this requirement. Preferably, the displacement setting of the machine 42 is set to a negative setting which permits the motor 36 to be sized for a lower torque setting if so desired. The state of the valve 52 is changed from the no-flow condition to the flow condition, and the fluid is permitted to flow between the machines 40, 42 so that in this case, the machines 40, 42 operate in the non-push-pull operation mode. In the non-push-pull operation mode: (i) the machines 40 and 42 operate in unison, and (ii) the pressure lines 56 and 62 are connected together. The machines 40 and 42 behave as a single variable-displacement pump, and depending upon the displacement and the direction of flow of the fluid through the machine 42, the drive 100 provides, at least in part, the fluid in either greater or lesser quantities to the actuator 30. If the valve 52 is set in the flow condition, the valve 46 remains in the flow condition, the valve 44 is set in the no-flow condition, and the valve 29 is set in the flow condition, the bore side 35 of the cylinder 34 of the actuator 30 is open to the tank 82 and the rod side 37 receives the fluid (or a net flow of fluid) from the machines 40, 42. By adjusting the displacement of the machines 40, 42 to a low displacement, it is possible to generate a high pressure by using (that is, activating) the motor 36.

By having a variable-displacement pump (as a combination of the machines 40 and 42), controlling the cavitation or the pressure inside the cylinder 34 may be achieved by altering, slightly, the displacement of the pump so that it is slightly greater displacement than the cylinder volume ratio (in other words the displacement ratio of 40 to 42 either exceeds or is less than the displacement ratio of the cylinder by a certain amount). By doing that, it is possible to either raise or lower the pressure in the cylinder (it may be required to use to maintain an above-atmospheric pressure level in the cylinder at all times to prevent cavitation). In other words, it is possible to make adjustments by means of this combination. When the valve 52 is closed, it is possible to adjust the pumping capacity of both sides to the ratio of the differential cylinder.

FIG. 2BB is a schematic representation of the drive 100 of FIG. 1 used for applying a mold break force to a mold of the molding system according to a variant. According to the variant, the fluid is used to pressurize the bore side 35 of the actuator 30 to apply the mold break force to the platen 22. Two actuators 30 are used. The rods 33 of the actuators 30 are connected to the stationary platen 22. The fluid is pushed into the bore sides 35 of the actuators 30 so as to impart the mold break force via the bore sides 35, through the pistons 32 and through the rods 33 to the platen 22.

FIG. 2C is a schematic representation of the drive 100 of FIG. 1 used for applying a stroking force to the movable platen 22 so as to open the mold 28 of the system 102. In FIG. 2C, the drive 100 and the system 102 are depicted in the case where the platen 22 is moved after the mold break force was successfully applied so as to break apart the mold portions 24, 26, so that now the platen 22 may be moved away from the platen 20 so as to provide sufficient room or space for the article removing device to reach into the separated mold 28 and grab the article 23 and remove the article 23 from the mold 28. In this case, the machines 40, 42 are operated in a low pressure and low flow condition (in the pressure lines). The displacement setting of the machine 42 may be positive if the motor 36 were configured to provide the required torque. It is preferred to operate the machine 42 in a negative displacement setting so that the motor 36 may operate in a lower torque output (so that the motor 36 may be smaller).

The state of the valve 52 changes from the flow condition to the no-flow condition. The machine 40 is operated as a motor while the machine 42 is operated as a pump. The machine 40 behaves as a motor by taking (pulling) fluid away from the actuator 30 and bringing the fluid to the tank 82 while the machine 42 behaves or operates as a pump by bringing the fluid from the tank 82 and pushing the fluid to the actuator 30. In this sense the machines 40, 42 act to push and to pull the fluid relative to the actuator 30. If the rod 33 is required to move to the left (that is, the rod 33 is to be retracted back into the cylinder 34), operation of motor 36 is reversed (the motor 36 turns counter clockwise, for example) and once the motor 36 is reversed: (i) the machine 42 takes the fluid from the tank 82 and supplies the fluid to the rod side 37 of the cylinder 34, and (ii) the machine 40 receives the fluid from the bore side 35 of the cylinder 34 and pumps the fluid into the tank 82 (this condition is called reverse flow).

Preferably, the mold break function is implemented with a high pressure and a low flow in the pressure line 62. So then after the mold 28 is broken apart, it is possible to operate the cylinder 30 under a high flow at a low pressure (in the pressure line). The valve 29 is set in the no-flow state, the valves 44, 46 are set in the flow condition and the valve 52 is set in the no-flow condition, and now in this operation mode (in differential cylinder mode), the actuator 30 may be driven to move the movable platen 22 (accelerate and decelerate the movable platen 22)

To summarize FIGS. 2A, 2B and 2C: since the machines 40 and 42 are connected by the shaft 38 to the motor 36, the machines 40 and 42 may operate under the following states in the non-push-pull operation mode (provided the motor 36 has sufficient torque to handle these states): (i) the machine 40 and the machine 42 operate in a uni-push operation state in which the machine 40 and the machine 42 operate to push a fluid to an actuator (such as actuator 30), and (ii) the machine 40 and the machine 42 operate in a net-push operation state in which the machine 40 pushes a fluid to an actuator, and the machine 42 pulls the fluid from the actuator so that a net flow of fluid is delivered to the actuator. The flow of fluid to an actuator is either bolstered (increase flow of the fluid) or reduced (reduce flow of fluid to the actuator) for the same rotation of the shaft 38. It is also contemplated that both of the machines 40, 42 may be operated so that: (i) the machines 40, 42 both pull the fluid from the actuator, and (ii) one of the machines 40, 42 pushes the fluid to the actuator while the other one of the machines 42 pulls the fluid from the actuator so that there is, in effect, a net pull of the fluid from the actuator. For the case where the machine 42 is operated to receive the fluid and if the machine 42 is a variable-displacement pump, the fluid is pumped out of the machine 40 and goes back in through the machine 42 (since the fluid is pressurized) and energy is recovered through the shaft 38, the motor 36 provides net power (difference in power) between the machines 40 and 42. The machine 40 outputs a volume of fluid at a certain rate, and some of the flow from the machine 40 may branch off and get delivered to an actuator and some other portion of the volume of fluid may end up flowing back into the machine 42. This arrangement, in effect, permits control of how much of the fluid goes into the actuator; when the fluid is pumped back into the machine 42 and some power is then regenerated back into the shaft 38, which then goes back into the machine 40, so that the motor 36 supplies the net torque that may be required. The machine 42, then, influences the behavior of machine 40 which, then, in turn takes less power from the shaft 38 in terms of its rotational power (more or less). This arrangement allows pumping a volume out of the combination of the machines 40 and 42. If the total flow out of the machines 40, 42 is taken, at the maximum pressure, there could be too much power required (by the machines 40, 42) and the motor 36 may not be able to turn (if the motor 36 cannot turn the size of the motor 36 may be increased if so desired). So what can be done is the output of the drive 100 is optimized to provide a desired power (power=flow times pressure) that matches the motor 36. This arrangement may provide a low flow of the fluid at a high pressure by decreasing the net displacement of the combination of the machines 40 and 42. One may supply high pressure at lower flow (in the pressure line 56) because the drive 100, in effect, behaves as a smaller-displacement pump. If a high flow of the fluid at a lower pressure is required, then that condition may be achieved by providing the fluid from both of the machines 40 and 42 at the full power output of the motor 36 (or any point less than that if so desired). So then the effect of the machines 40 and 42 may be added together or they can be subtracted from each other. Control of the flow going through the valve 52 may be achieved as function of the rotational speed of the motor 36 and of the displacement that is set for each of the machines 40, 42. Each of the machines 40, 42 has its dedicated controller 41, 43 (respectively) that has to be set up for a desired performance; control of the valve 52 may be achieved via software control (for example, the software control residing as computer-executable code that resides in the memories of the controllers 41, 43, etc). The valve 52 is either controlled to open or close (selectively, under software control) so that the machine 42 will either take in the fluid or deliver out the fluid depending on the software-control commands initiated by either operator control or initiated by software control (responsive to sensor inputs, a current mode of operation of the system 102, etc).

An advantage, from amongst others, is that the drive 100 may be used for a function such as injection of the molding material 10 into the mold 28 (where it may be required to provide a higher flow rate but at a lower pressure). This arrangement may be achieved by using (nominally) maximum allowable power from motor 36. In sharp contrast to a fixed-displacement pump of the known art where, if there is a single fixed displacement machine or multiple fixed-displacement machines, the fixed displacement machine provides flow directly to an actuator, and the flow of the machine is limited purely by the maximum pressure that has to be developed with the machine and that determines the power of a motor. So if there is a certain amount of displacement in the known machine, there is a need for a certain amount of torque (to be provided by the motor) to drive the machine at the peak pressures, and that would determine the motor power. So if it is desired to provide more flow at less pressure, there appears to be no opportunity to do that with a fixed-pump arrangement (according to the known art).

The arrangement of the first exemplary embodiment offers an advantage, from amongst other advantages, of being able to drive an actuator, and the actuator is used to move a movable mass (such as a platen or a screw, etc). The movement of the mass can be stopped by using the machines 40, 42, under full, at least in part, drive control of the machines 40, 42. The drive 100 is also usable for powering a single-acting actuator as well, using the maximum benefits of either high flow and low pressure, or low flow and high pressure (in the pressure line 56) depending on the configuration of the system 102.

The drive 100 can be used to power a plurality of actuators (by using a hydraulic switching circuit or network), and in that case each hydraulic line has a lock out so that it is possible to sequentially shift the fluid to selected actuators and direct the fluid to whichever actuator is desired to be driven or powered. It is possible to drive multiple or single-acting cylinders. It is possible to drive multiple differential cylinders as well, but not simultaneously (it would be possible to drive one differential cylinder at a time, sequentially). If it is desired to simultaneously drive multiple differential cylinders, another drive 100 would be needed to simultaneously drive multiple differential cylinders. It is possible to arrange the drive 100 and a supporting hydraulic circuit to simultaneously drive multiple actuators if there is no concern about controlling the positions of the actuators; it would be possible to drive two cylinders against their respective hard stops and so therefore driving multiple cylinders could be done simultaneously if there were a suitable hydraulic circuit arranged for the drive 100 to do just so.

It is possible to have machines 40, 42 that are much bigger in total displacement than would ordinarily be able to be driven by the motor 36, and to use the drive 100 to control the flow of a large amount of fluid without a lot of installed power (that is power of the motor 36) at high flow rates at low pressure (in the pressure line that is connected to an acutator). This arrangement provides a technical effect or advantage over a known motor used with a known fixed-pump design. The machines 40, 42 can operate (i) in an individual mode (that is, both machines 40, 42 can individually operate on different respective sides of an actuator) or (ii) in a delta mode. In the delta mode, both machines 40, 42 act on one side of an actuator to provide a flow (either a sum of the output flows from the machines 40, 42 or a net of the output flow from the machines 40, 42) to the actuator. So the drive 100 enables usage of a lighter variety of designs of machines compared with a known hydrostatic design where the known design uses both suction and outlet side of a pump under pressure (depending on the direction of the operation of the pump).

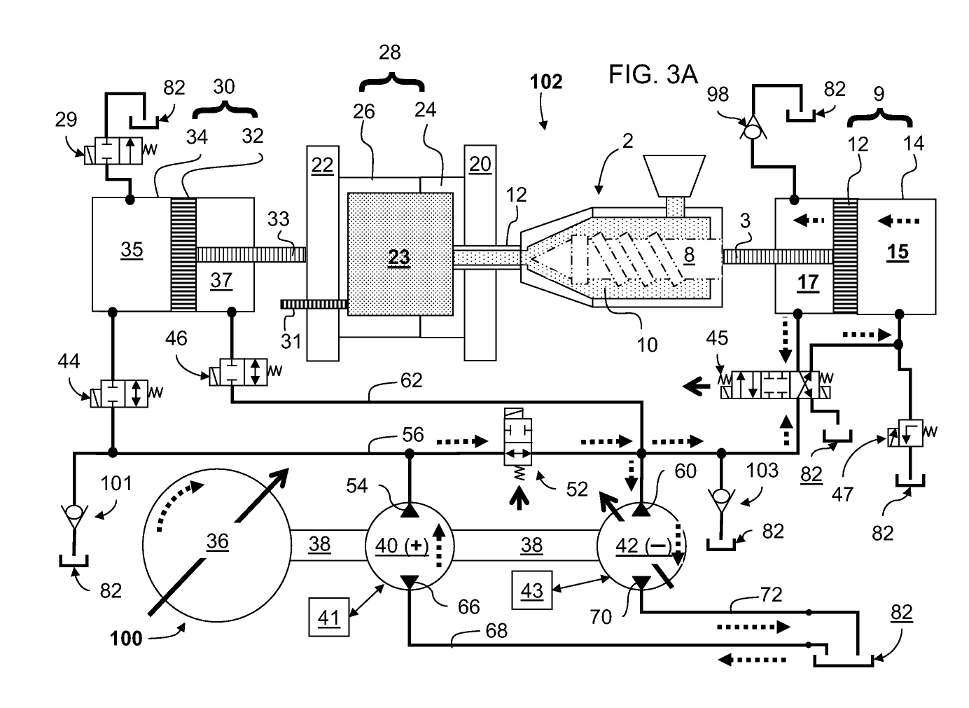

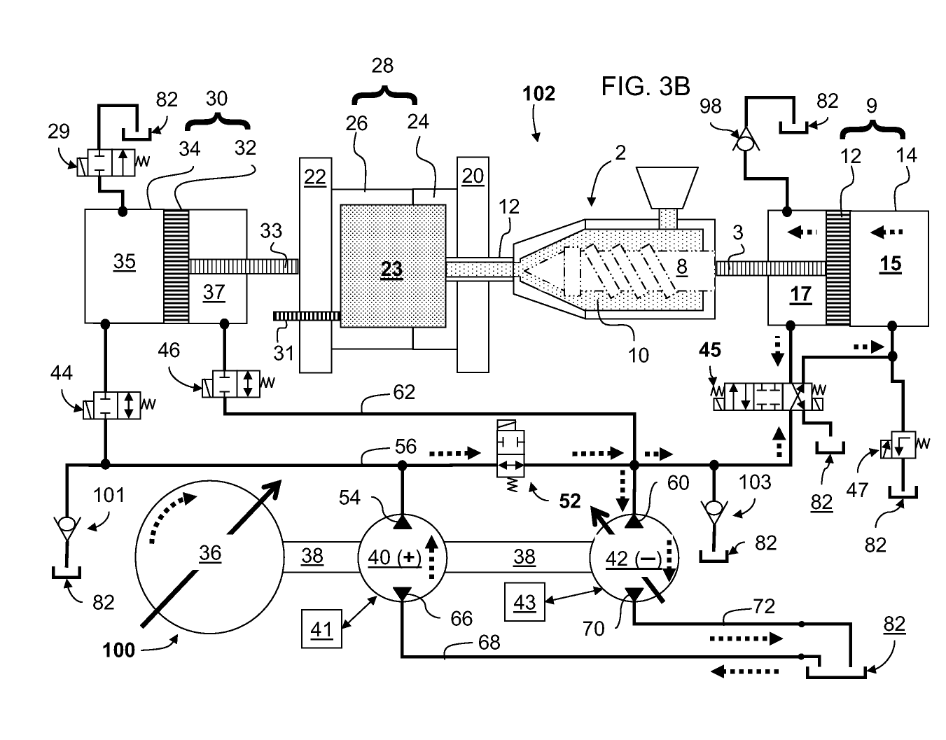

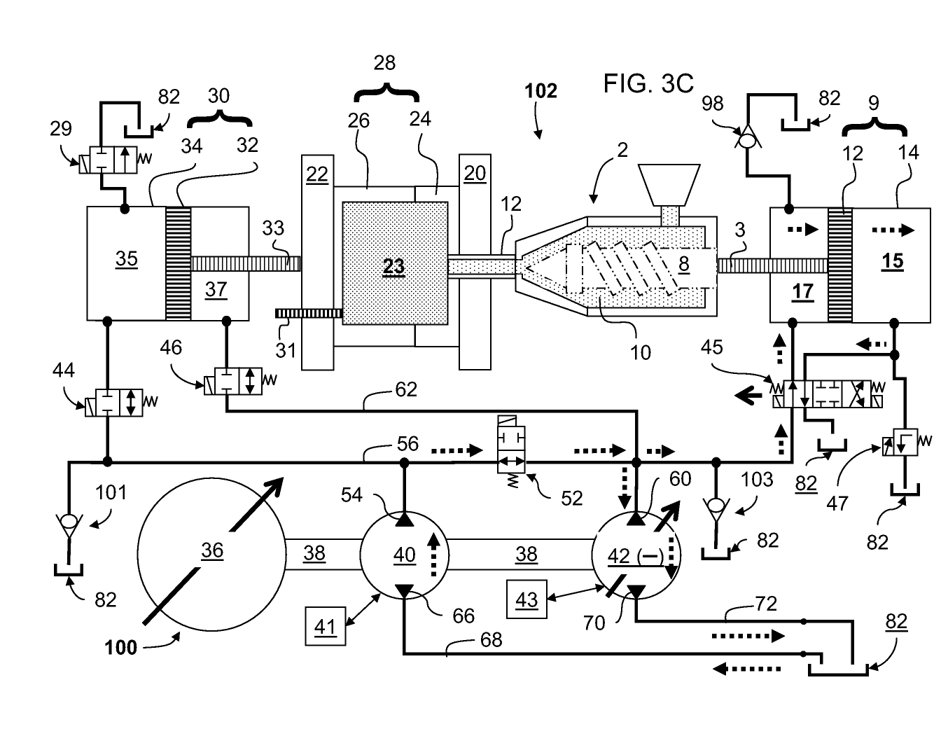

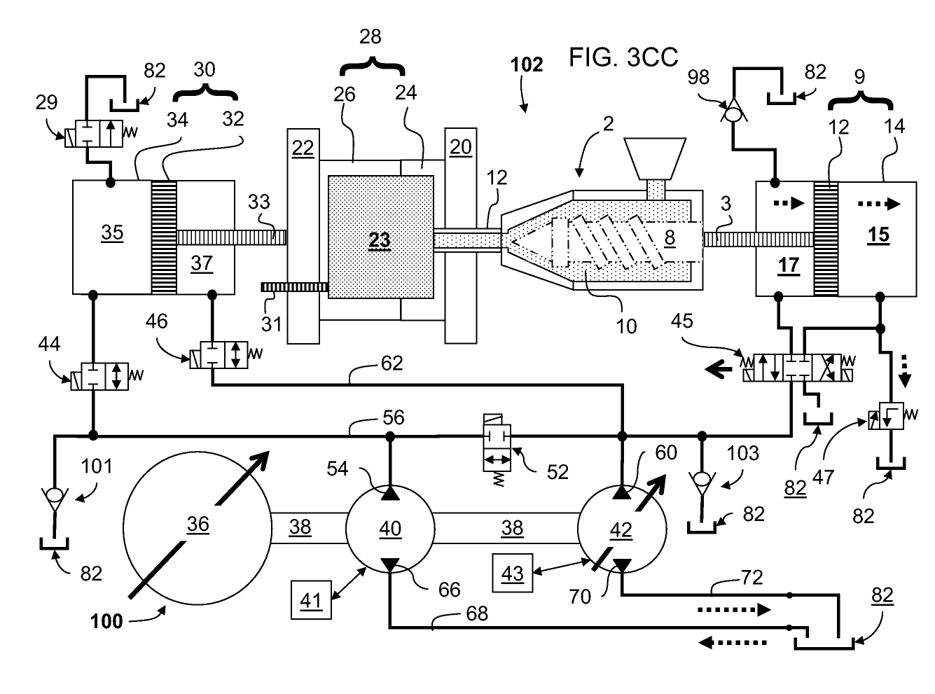

FIG. 3A is a schematic representation of the drive 100 of FIG. 1 used for applying an injection stroke to the screw 8 of the extruder 2 to inject the molding material 10 into the mold 28 of the system 102. In FIG. 3A, the drive 100 and the system 102 are depicted in an injection state (also called a mold-fill state), in which the screw 8 is stroked so as to inject the molding material 10 into the mold 28. In the depicted state, the displacement setting of the machine 40, preferably, is set to +100% and the displacement setting of the machine 42 is, preferably, set to −100%. The pressure is high and the flow is low (power=pressure×flow). The displacement setting of the machine 42 may be positive if the motor 36 has enough torque to satisfy this requirement; preferably, the displacement setting of the machine 42 is set to a negative value. There are two ways to inject the molding material: (i) one way is to use high pressure and low flow in the pressure line leading to the actuator 9, as depicted in FIG. 3A); or (ii) another way is to use high flow and low pressure in the pressure line (that is, the displacement setting of the machine 42 is set for a positive displacement). A technical advantage of the drive 100, over an all-electric molding system, is that if the all-electric molding system were to use the same motor 36 as used by the drive 100, the screw 8 of the system 102 may be operated at a higher velocity in comparison to a screw driven by the same motor 36 in the all-electric molding machine.

If the valve 45 changes state, and the valve 52 is set in the flow condition, and the machines 40, 42 are operated to both deliver the fluid (that is, either a net or delta of the fluid, or a sum of the fluid from the machines 40, 42) to one side of the actuator 9, the fluid is delivered to the bore side 15 of the actuator 9 once the valve 45 is set to do so as depicted. The valve 45 also connects the rod side 17 to the tank 82 so that the fluid may flow to the tank 82. As a result the piston 12 is moved so as to extend the rod 3 from the actuator 9 so that in effect the screw 8 may be stroked (that is, the screw 8 may inject the molding material 10 into the mold 28).

FIG. 3B is a schematic representation of the drive 100 of FIG. 1 used for applying a holding force to the molding material 10 that has been injected into the mold 28 of the system 102. FIG. 3B depicts the drive 100 and the system 102 in a hold phase or a clamp-up phase, in which the pressure is, preferably, set for maximum and the flow is set, preferably, for flow. The mold 28 becomes filled with the molding material 10. The machines 40, 42 are controlled by their respective controllers 41, 43 to provide maximum pressure at low flow during application of the holding force (this condition is also called the clamp-up phase).

FIG. 3C is a schematic representation of the drive 100 of FIG. 1 used for applying a pullback stroke to the screw 8 of the extruder 2 of the system 102 of FIG. 1 so as to retract the screw 8. FIG. 3C depicts the drive 100 and the system 102 in a pullback phase (sometimes called a suckback phase) in which the screw 8 is pulled back so as to depressurize the molding material located in the machine nozzle 12 and cause a negative pressure in the machine nozzle 12; this phase mitigates drooling once the mold portions 24, 26 are seperated from each other. The valve 45 changes state so that the flow of the fluid from the machines 40, 42 (either the delta flow or a sum flow) is delivered to the bore side 17 of the actuator 9, so that in effect the screw 8 may be retracted (and thereby cause negative pressure in the machine nozzle 12).

FIG. 3CC is a schematic representation of the drive 100 of FIG. 1 used for applying a recovery stroke to the screw 8 of the extruder 2 of the system 102 (of FIG. 1) so as to recover a shot of molding material. FIG. 3CC depicts the drive 100 and the system 102 in a recovery phase. During the recovery phase, the valve 45 is shut off (no flow condition). During recovery, the screw 8 is turning and preparing the next shot (of molding material). The accumulation of the shot in front of the screw 8 pushes the screw 8 backwards and displaces the fluid from the cylinder bore 15. By controlling the rate at which the fluid can escape (from the bore side 15) and this action causes an increase in the pressure of plastic being processed and makes the screw 8 work the molding material 10 harder thereby increasing friction and melting of the molding material 10. There is no powering of the screw 8 backwards during the recovery phase and consequently there is no hydraulic flow to the rod side 17 of the cylinder (from the machines 40, 42). A valve 47 (also called a back pressure control valve that uses proportional control) is used to actively control and maintain the pressure in the bore side 15 of the actuator 9.

FIGS. 4A, 4B, 4C are schematic representations of the drive 100 of FIG. 1 used for applying a carriage stroke force to the extruder 2 so as to move the extruder 2 relative to the mold 28 of the system 102. In FIGS. 4A, 4B, 4C, the drive 100 and the system 102 are depicted in a carriage no-movement condition, in which the extruder 2 is not movable relative to the mold 28. In the arrangement depicted in FIG. 4A, an actuator 200 is placed in an un-driven state. The drive 100 is used to drive the actuator 200. The actuator 200 is used to position or to move (once driven by the drive 100) a carriage (not depicted) of the extruder 2, so that in effect the extruder 2 may be positioned relative to the mold 28. A valve 290 is coupled to the pressure line 56. Another pressure line couples the valve 290 to a shut-off valve 292 which in turn is coupled to a rode side 237 of a cylinder 232 of the actuator 200. A rod 233 is connected to the carriage of the extruder 2. A piston 234 is connected to the rod 233, and the piston 234 is slidable in the cylinder 232. A bore side 235 of the cylinder 232 of the actuator 200 is connected back to the valve 290. The valve 290 is also connected to the tank 82.

In the arrangement depicted in FIG. 4B, the drive 100 and the system 102 are depicted in a carriage movement state in which the carriage and the extruder 2 (of FIG. 1) are moved closer or toward the mold 28 (that is, the extruder 2 is moved into position). It is preferred that the displacement setting of the machine 42 is a negative value. The actuator 200 is driven by the drive 100 to move the carriage so that the extruder 2 may be positioned toward the mold 28. The machines 40, 42 are actuated and a flow of the fluid is delivered to the rod side 237 of the actuator 200 (via the valves 290, 292 once these valves are so positioned to do so).

In the arrangement depicted in FIG. 4C, the actuator 200 is driven by the drive 100 to move the carriage so that the extruder 2 may be positioned away from the mold 28. The machines 40, 42 are actuated and a flow of the fluid is delivered, via the valves 290, 292 once this valve so positioned to do so, to the bore side 235 of the actuator 200.

It is understood that the actuator 200 may be arranged so at to (i) connect the rod 233 to the carriage of the extrduer 2 and to connect the cylinder 232 to the stationary platen 20 or (ii) connect the rod 233 to the stationary platen 20 and to connect the cylinder 232 to the carriage of the extruder 2.

FIGS. 5A and 5B are schematic representations of the drive 100 of FIG. 1 used for applying a clamping force to the mold 28 of the system 100 (of FIG. 1). In FIG. 5A, the drive 100 and the system 102 are depicted in a no-clamp force applied stated. In the arrangement depicted in FIG. 5A, an actuator 300 is placed in an un-driven state. The drive 100 is used to drive the actuator 300. The actuator 300 is used to apply a clamping force (once driven by the drive 100) to a clamp (not depicted). The clamp is coupled to a tie bar (not depicted) that extends between the movable platen 22 and the stationary platen 20. A valve 380 is coupled to the pressure line 56. Another pressure line couples the valve 380 to a bore side 335 of a cylinder 332 of the actuator 300. A rod 333 is connected to the clamp. A piston 334 is connected to the rod 333, and the piston 334 is slidable in the cylinder 332. A rod side 337 of the cylinder 332 of the actuator 300 is not connected to the drive 100 or to the tank 82. The bore side 335 is connected to a valve 382 which is then connected to the tank 82. The valve 382 is in the flow condition so that the clamping force is not inadvertently applied to the mold 28.

In FIG. 5B, the drive 100 and the system 102 are depicted in a clamp-force applied state, in which a clamping force is applied to the mold 28. Preferably, the pressure is high and the flow is low (in the pressure line 56). In the arrangement depicted in FIG. 5B, the valve 382 is placed in the no-flow condition, and the actuator 300 is driven by the drive 100 to apply the clamping force, via the rod 333. The machines 40, 42 are actuated and a flow of the fluid is delivered, via the valve 380 (once the valve 380 is so positioned to do so) to the bore side 335 of the actuator 300.

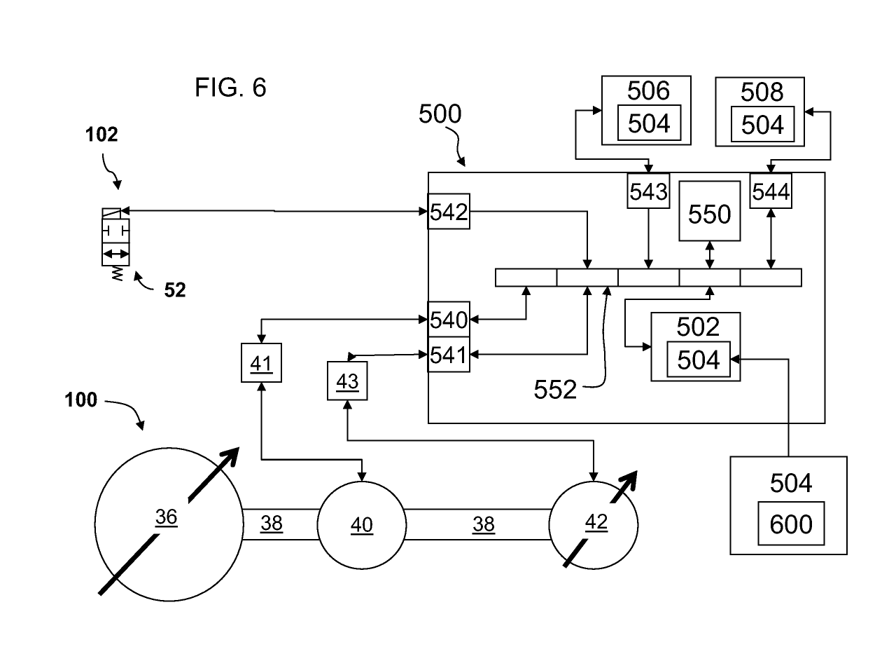

FIG. 6 is a schematic representation of a controller 500 that is operatively cooperative with the drive 100 of FIG. 1. The controller 500 includes a controller-usable medium 502 embodying instructions 504 that are executable by the controller 500. The instructions 504 include executable instructions for directing the controller 500 to operate the machine 40 and the machine 42 in a push-pull operation mode. According to a variant, the instructions 504 are delivered to the controller 500 via a network-transmittable signal 508 that includes a carrier signal modulatable to carry the instructions 504. The network-transmittable signal 508 is transmittable over a network, such as the Internet so that the instructions 504 are receivable via an interface 544 of the controller 500. According to another variant, the instructions 504 are delivered to the controller 500 via an article of manufacture 506 that includes a controller-usable medium embodying the instructions 504. The article of manufacture 506 may be a CD (Compact Disk), floppy disk, flash memory, optical disk, etc. The article of manufacture 506 is interfacable with an interface 543 of the controller 500. The interfaces 544, 543 are well known in the art. The controller 500 may include a display unit and/or a keyboard (both not depicted) to assist operator (human) interfacing. The controllers 41, 43 are electrically connected (wired or wireless communications) to an interface 540, 542, respectively, of the controller 500. The valve 52 is electrically connected (wired or sireless communications) to an interface 542 of the controller 500. Preferably, the controller 500 includes a CPU (Central Processing Unit) 550 that is used to execute the instructions 504. A bus 552 operatively connects the CPU 550 with the interface units 540 to 544 and to the controller-usable medium 502. An operation 600 of the instructions 504 is coded in programmed statements by using a programming language, such as (i) a high-level language (C++ or Java, etc) which is then translated to machine language or (ii) assembly/machine language of a particular processor used in the controller 500. The instructions 504 are executable by the controller 500. Operation 600 includes directing the controller 500 to operate the machine 40 and the machine 42 in a push-pull operation mode. Other instructions, not depicted, may be used as well, as may be inferred from the description above.

The description of the exemplary embodiments provides examples of the present invention, and these examples do not limit the scope of the present invention. It is understood that the scope of the present invention is limited by the claims. The exemplary embodiments described above may be adapted for specific conditions and/or functions, and may be further extended to a variety of other applications that are within the scope of the present invention. Having thus described the exemplary embodiments, it will be apparent that modifications and enhancements are possible without departing from the concepts as described. It is to be understood that the exemplary embodiments illustrate the aspects of the invention. Reference herein to details of the illustrated embodiments is not intended to limit the scope of the claims. The claims themselves recite those features regarded as essential to the present invention. Preferable embodiments of the present invention are subject of the dependent claims. Therefore, what is to be protected by way of letters patent are limited only by the scope of the following claims:

What is claimed is:

1. A drive of a molding system, comprising:
a first hydraulic machine; and
a second hydraulic machine cooperative with the first hydraulic machine, the first hydraulic machine and the second hydraulic machine being operative in a push-pull operation mode.

2. The drive of claim 1, wherein the first hydraulic machine and the second hydraulic machine are operative in a uni-push operation mode.

3. The drive of claim 1, wherein the first hydraulic machine and the second hydraulic machine are operative in an operation mode selected from one of the push-pull operation mode and the uni-push operation mode.

4. The drive of claim 1, wherein in the non-push-pull operation mode, the first hydraulic machine and the second hydraulic machine operate in a uni-push operation state.

5. The drive of claim 1, wherein in the non-push-pull operation mode, the first hydraulic machine and the second hydraulic machine operate in a uni-push operation state, wherein the in uni-push operation state the first hydraulic machine and the second hydraulic machine operate to push a fluid to an actuator.

6. The drive of claim 1, wherein in the non-push-pull operation mode, the first hydraulic machine and the second hydraulic machine operate in a net-push operation state.

7. The drive of claim 1, wherein in the non-push-pull operation mode, the first hydraulic machine and the second hydraulic machine operate in a net-push operation state, wherein in the net-push operation state, the first hydraulic machine pushes a fluid to an actuator, and the second hydraulic machine pulls the fluid from the actuator so that a net flow of fluid is delivered to the actuator.

8. The drive of claim 1, wherein in the push-pull operation mode, the first hydraulic machine and the second hydraulic machine behave as a complementary pump-motor group.

9. The drive of claim 1, wherein in the push-pull operation mode, the first hydraulic machine and the second hydraulic machine alternatively behave as a pump and as a motor.

10. The drive of claim 1, wherein in the push-pull operation mode, the first hydraulic machine operates as a pump while the second hydraulic machine behaves as a motor.

11. The drive of claim 1, wherein in the push-pull operation mode, the first hydraulic machine operates as a motor while the second hydraulic machine behaves as a pump.

12. The drive of claim 1, wherein in the push-pull operation mode, the first hydraulic machine behaves as a pump by bringing fluid to an actuator while the second hydraulic machine behaves as a motor by taking the fluid away from the actuator.

13. The drive of claim 1, wherein in the push-pull operation mode, the first hydraulic machine behaves as a motor by taking fluid away from an actuator while the second hydraulic machine behaves as a pump by bringing the fluid to the actuator.

14. The drive of claim 1, wherein in the push-pull operation mode, the first hydraulic machine behaves as a pump by bringing fluid from a tank to an actuator while the second hydraulic machine behaves as a motor by taking the fluid away from the actuator and bringing the fluid to the tank.

15. The drive of claim 1, wherein in the push-pull operation mode, the first hydraulic machine behaves as a motor by taking fluid away from an actuator to a tank while the second hydraulic machine behaves as a pump by bringing the fluid from the tank to the actuator.

16. The drive of claim 1, wherein in the push-pull operation mode,
a pressure side of the first hydraulic machine fluidly communicates, at least in part, with a first chamber of an actuator, and a non-pressure side of the first hydraulic machine is fluidly communicating, at least in part, with to a tank, and
a pressure side of the second hydraulic machine fluidly communicates, at least in part, with a second chamber of the actuator, and a non-pressure side of the second hydraulic machine is fluidly communicating with the tank.

17. The drive of claim 1, wherein in the push-pull operation mode, the first hydraulic machine and the second hydraulic machine are drivable by a motor, the motor is operable in a bi-directional mode.

18. The drive of claim 1, wherein in a uni-push operation mode, a valve isolates a high pressure side of the first hydraulic machine and a high pressure side of the second hydraulic machine.

19. The drive of claim 1, wherein in a uni-push operation mode, the first hydraulic machine and the second hydraulic machine behave as a pump group.

20. The drive of claim 1, wherein in a uni-push operation mode, the first hydraulic machine and the second hydraulic machine both behave as a pump.

21. The drive of claim 1, wherein in a uni-push operation mode, the first hydraulic machine brings a fluid to an actuator and the second hydraulic machine brings the fluid to the actuator.

22. The drive of claim 1, wherein in a uni-push operation mode, the first hydraulic machine brings a fluid from a tank to an actuator and the second hydraulic machine brings the fluid from the tank to the actuator.

23. The drive of claim 1, wherein in a uni-push operation mode,
a pressure side of the first hydraulic machine is fluidly communicating, at least in part, with a first chamber of an actuator, and a non-pressure side of the first hydraulic machine is fluidly communicating, at least in part, with to a tank,
a pressure side of the second hydraulic machine is fluidly communicating, at least in part, with the first chamber of the actuator, and a non-pressure side of the second hydraulic machine is fluidly communicating with the tank, and
a second chamber of the actuator is fluidly communicating, at least in part, with the tank.

24. The drive of claim 1, wherein in a uni-push operation mode, the first hydraulic machine and the second hydraulic machine are drivable by a motor, the motor is operable in a uni-directional mode.

25. The drive of claim 1, wherein in a uni-push operation mode, a valve fluidly communicates a fluid between a high pressure side of the first hydraulic machine and a high pressure side of the second hydraulic machine.

26. The drive of claim 1, wherein the first hydraulic machine includes a fixed-displacement pump.

27. The drive of claim 1, wherein the second hydraulic machine includes a variable-displacement pump.

28. The drive of claim 1, wherein the first hydraulic machine and the second hydraulic machine are drivable by a motor.

29. The drive of claim 1, wherein the first hydraulic machine and the second hydraulic machine are drivable by a motor, the motor being drivable in a selected one of a bi-directional mode and a uni-directional mode.

30. The drive of claim 1, wherein the first hydraulic machine and the second hydraulic machine are coupled to an actuator.

31. The drive of claim 1, wherein the first hydraulic machine and the second hydraulic machine are coupled to an actuator, the actuator included in a platen-stroke actuator.

32. The drive of claim 1, wherein the first hydraulic machine and the second hydraulic machine are coupled to an actuator, the actuator included in an injection actuator of an extruder.

33. The drive of claim 1, wherein the first hydraulic machine and the second hydraulic machine are coupled to an actuator, the actuator included in an ejector.

34. The drive of claim 1, wherein the first hydraulic machine and the second hydraulic machine are coupled to an actuator, the actuator included in a clamp unit.

35. The drive of claim 1, wherein the first hydraulic machine is operatable as a pump and as a motor.

36. The drive of claim 1, wherein the second hydraulic machine is operatable as a pump and as a motor.

37. The drive of claim 1, wherein the first machine includes a fixed-displacement type hydraulic pump.

38. The drive of claim 1, wherein the second machine includes a variable-displacement type hydraulic pump.

39. A drive of a molding system, comprising:
a first hydraulic machine configured to cooperate with a second hydraulic machine, the first hydraulic machine and the second hydraulic machine being operative in an operation mode selected from one of a push-pull operation mode and a uni-push operation mode.

40. A molding system, comprising:
a drive, including a first hydraulic machine, the first hydraulic machine configured to cooperate with a second hydraulic machine, the first hydraulic machine and the second hydraulic machine being operative in a push-pull operation mode.

41. A molding system, comprising:
a movable component;
an actuator coupled to the movable component and configured to move the movable component; and
a drive, including: (i) a first hydraulic machine, and also including (ii) a second hydraulic machine cooperative with the first hydraulic machine, the first hydraulic machine and the second hydraulic machine being operative in a push-pull operation mode.

42. A method of a drive of a molding system, comprising:
operating a first hydraulic machine and a second hydraulic machine in a push-pull operation mode.

43. A controller of a drive of a molding system, the controller comprising:
a controller-usable medium embodying instructions being executable by the controller, the controller operatively couplable to the drive, the drive having a first hydraulic machine and a second hydraulic machine, the instructions including executable instructions for directing the controller to operate the first hydraulic machine and the second hydraulic machine in a push-pull operation mode.

44. The controller of claim 43, wherein the controller is configured to control a first controller coupled to the first hydraulic machine, and the controller is configured to control a second controller coupled to the second hydraulic machine.

45. An article of manufacture of a controller of a drive of a molding system, the article of manufacture comprising:
a controller-usable medium embodying instructions being executable by the controller, the controller operatively couplable to the drive, the drive having a first hydraulic machine and a second hydraulic machine, the instructions including executable instructions for directing the controller to operate the first hydraulic machine and the second hydraulic machine in a push-pull operation mode.

46. The article of manufacture of claim 45, wherein the controller is configured to control a first controller coupled to the first hydraulic machine, and the controller is configured to control a second controller coupled to the second hydraulic machine.

47. A network-transmittable signal of a controller of a drive of a molding system, the network-transmittable signal comprising:
a carrier signal modulatable to carry instructions being executable by the controller, the controller operatively couplable to the drive, the drive having a first hydraulic machine and a second hydraulic machine, the instructions including executable instructions for directing the controller to operate the first hydraulic machine and the second hydraulic machine in a push-pull operation mode.

48. The network-transmittable signal of claim 47, wherein the controller is configured to control a first controller coupled to the first hydraulic machine, and the controller is configured to control a second controller coupled to the second hydraulic machine.
